(19) United States
(12) Patent Application Publication
(10) Pub. No.: US 2008/0201689 A1
(43) Pub. Date: Aug. 21, 2008

(54) Vector Crc Computatuion on Dsp

(75) Inventor: Bo Lin, East Kilbride (GB)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc., Austin, TX (US)

(21) Appl. No.: 11/994,251

(22) PCT Filed: Jun. 30, 2005
(86) PCT No.: PCT/EP2005/053119

§ 371 Date: Dec. 28, 2007

(51) Int. Cl. G06F 9/44

(52) U.S. Cl. 717/106

(57) ABSTRACT

A method of generating Cyclic Redundancy Checking codes based upon an N-bit binary string comprises initially compressing the N-bit binary string into a compressed string of bits using a compression look-up table. The compressed string of bits is congruent with the N-bit binary string and so share a same CRC code. Using the compressed string of bits, a conventional CRC generation technique is employed to generate the CRC code.

### FIELD OF THE INVENTION

This invention relates to a method of generating a code of the type, for example, used to verify integrity of data, such as between a source node and a destination node in a communications network. This invention also relates to a processing apparatus of the type, for example, that processes data to generate a code, such as is used to verify integrity of data.

### BACKGROUND OF THE INVENTION

In the field of digital communications, data is commonly communicated from a source node to a destination node. Typically, the source node, having a block of data to be transmitted, appends a code to the block of data, the code relating to the block of data to be transmitted and serving as a mechanism for verifying that the block of data is free of errors upon receipt thereof following transmission. One example of this technique is known as Cyclic Redundancy Checking (CRC), and involves the source node applying a 16- or 32-bit polynomial to the block of data, the result of the polynomial constituting a CRC code that is appended to the block of data. Upon receipt of the block of data and the CRC code by the destination terminal, the destination terminal applies a same polynomial to the block of data, the result of the same polynomial being compared with the CRC code appended by the source node. If the result of applying the polynomial at the destination node agrees with the CRC code appended to the block of data received, the block of data is deemed received free of errors. However, in the event that the result of the application of the polynomial at the destination node does not match the CRC code appended by the source node, the destination node usually notifies the source node to re-transmit the block of data.

This technique is used in relation to a number of communication technologies, for example: Media Access Control (MAC) of Ethernet, Third Generation wireless communications systems as standardised by the Third Generation Partnership Project (3GPP), as well as certain aspects of Internet-related technology, such as Stream Control Transmission Protocol (SCTP) and the Asynchronous Transfer Mode (ATM) Adaptation Layer 5 (AAL-5).

G. Griffiths and G. C. Stones, “The tea-leaf reader algorithm: An efficient implementation of CRC-16 and CRC-32” (Communications of the ACM, vol. 30, No. 7, July 1987), T. V. Ramabadran, S. S. Gaitonde, “A Tutorial on CRC Computations” (IEEE Micro, August 1988), and D. V. Sarwate, “Computation of Cyclic Redundancy Checks via Table Look-up” (Communications of the ACM, vol. 31, No. 8, August 1988) all describe conventional “parallel CRC calculation” techniques for generating CRC codes based upon contemporaneous look-ups of multiple bits. An exclusive-OR (XOR) is then performed on the result of the look-up and a successive input bit-string to generate a new value as an index for a subsequent look-up. Hence, generation of an index relies upon the result of a previous look-up.

The above-described data dependency represents a bottleneck to maximising performance of Central Processing Units (CPUs) in relation to modern high-performance microprocessors. For example, if a look-up (a load instruction) takes three cycles to complete, then four data-dependent look-ups take twelve cycles on any CPU architecture. In contrast, four data-independent look-ups are completed in fewer cycles than an equivalent number of data-dependent look-ups. In this respect, a pipelined super-scalar CPU can complete four data-independent table look-ups in seven cycles if one table look-up takes three cycles to complete. Other architectures, supporting parallel multiple memory bank accesses, such as StarCore developed by StarCore, LLC, or the TI C6xx family of processors available from Texas Instruments, only require three cycles to carry out four data-independent table look-ups. This is achieved by duplicating the table in four different memory banks, one table look-up taking three cycles to complete.

However, although data-independency is desirable, data-dependency is inevitable due to the nature of the mathematics underlying the technique, i.e. since the process of problem solving used to generate the CRC code needs related data.

### STATE OF INVENTION

According to the present invention, there is provided a processing apparatus and a method of generating a code for verifying integrity of data as set forth in the appended claims.

### BRIEF DESCRIPTION OF THE DRAWINGS

At least one embodiment of the invention will now be described, by way of example only, with reference to the accompanying drawings, in which:

FIG. 1 is a schematic diagram of a processing apparatus for implementing an embodiment of the invention;

FIG. 2 is a schematic diagram of data structures manipulation and date look-ups constituting the embodiment implemented by the apparatus of FIG. 1;

FIG. 3 is a schematic diagram of data structuring used in the embodiment implemented in FIG. 2;

FIG. 4 is a schematic diagram of an implementation of part of the embodiment of FIG. 2 using a vector-based parallel processor;

FIG. 5 is a schematic diagram of nibble manipulation for the vector-based implementation of FIG. 4;

FIG. 6 is a flow diagram of a method corresponding to the embodiment of FIG. 2; and

FIG. 7 is a schematic diagram of an implementation of another part of the embodiment of FIG. 2.

### DESCRIPTION OF PREFERRED EMBODIMENTS

Throughout the following description identical reference numerals will be used to identify like parts. In relation to changes to bits, updated parts of bit streams described herein will be underlined.

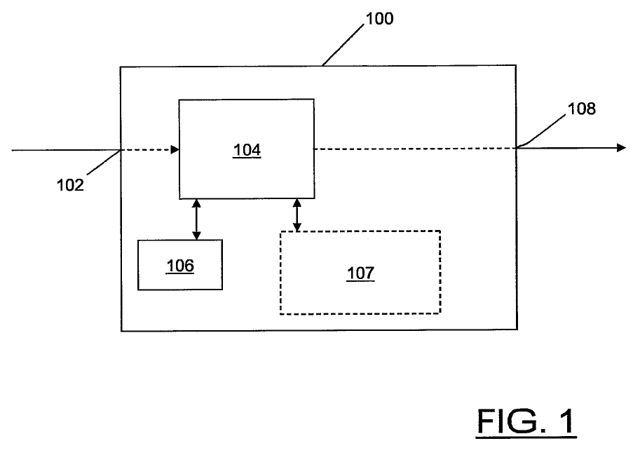

Referring to FIG. 1, a communications device/apparatus (not shown) implements, when in use, an improved Cyclic Redundancy Checking (CRC) algorithm. The exact nature of the device/apparatus is unimportant for the purpose of describing implementation of the improved CRC algorithm and so will not be described in any further detail herein. However, the skilled person will appreciate that implementation of the improved CRC algorithm, or any other algorithm employing the technique described herein, is not solely limited to communications devices/apparatus.

The communications device/apparatus comprises an MC7447 32-bit processor available from Freescale Semiconductor, Inc. and constituting a processing resource 100. The skilled person will, however, appreciate from the description later herein that the above-described functionality can be implemented on other 32-bit processors.

The processing resource 100 has a scalar core and comprises, inter alia, an input 102 coupled to a Load/Store Unit (LSU) 104 capable of communicating with an Integer Unit (IU) 106 and a parallel processing unit, such as a so-called “AltiVec” Single Instruction Multiple Data (SIMD) engine 107, the LSU 104 also being coupled to an output 108. The skilled person will, of course, appreciate that the processing resource 100 comprises other operational units not described herein for the sake of conciseness and simplicity, since such operational units do not have a direct bearing on the examples described herein.

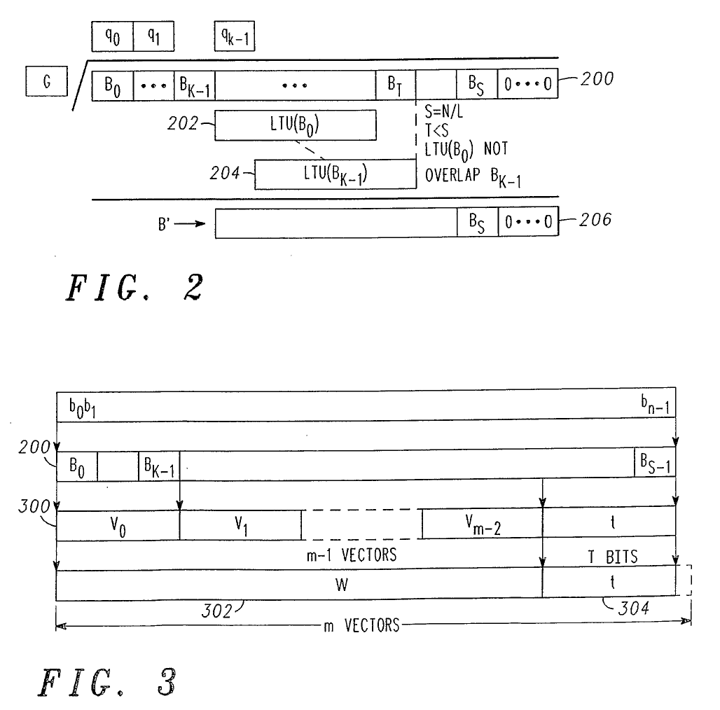

Turning to FIG. 2, the principle of operation of the improved CRC algorithm will now he described to provide the skilled person with a better understanding of the implementation of the improved CRC algorithm by the processing resource 100, so that the skilled person will further appreciate the numerous potential applications of the principle in relation to generation of codes to verify integrity of data.

An N-bit binary string, B, 200 is defined as B(x)=b₀x^{N-1}+b₁x^{N-2}+ . . . +b_{N-2}x+b_{N-1}, i.e. B=b₀b₁ . . . b_{N-1}. A fixed (M+1)-bit value is likewise defined as G(x)=g₀x^{M}+g₁x^{M-1}+ . . . +g_{M-1}x+g_{M}.

A CRC code for the N-bit binary string, B, is an M-bit value defined as an M-bit value CRC_{M}=c₀c₁ . . . c_{M-1}, where cᵢ (i=0, 1, 2, . . . , M−1) are coefficients of the polynomial CRC_{M}(x)=c₀x^{M-1}+ . . . +c_{M-2}x+c_{M-1}=B(x)·x^{M} mod G(x). That is, the CRC code, CRC_{M}, is the remainder of left-shifting the string B(x) by M bits and then divided by G(x).

An L-bit parallel processing approach to calculating the CRC code over B can be achieved when B is accessed in units of length L bits, i.e. L-bit units, and a 2^{L} entry table is provided to store the CRC_{M} values, for 2^{L} L-bit units, i.e. pre-calculating a look-up table, LTU, defined as LTU(z)=CRC_{M}(z) for z=0, 1, 2, . . . , 2^{L}−1. For example, if L=8, we have a byte-wise table look-up approach to calculate the CRC code.

A conventional approach to generating the CRC code handles the N-bit binary string, B, as a plurality of L-bit wide data units, Bᵢ, and iteratively performs a look-up in the look-up table, LTU, in respect of each L-bit wide data unit, Bᵢ, in turn, according to a known pattern of table look-ups. For each iteration, an exclusive-OR (XOR) function is then performed on a result obtained from the look-up table and a previous result of the XOR function. In this respect, for example, a 2^{nd} lookup LTU(B₁′) relies upon a 1^{st} lookup result LTU(B₀), while a 3^{rd} lookup relies on a 2^{nd} lookup result and so on. A final remainder of the above process is the desired CRC_{M} value.

In contrast, the improved CRC algorithm “postpones” the data-dependent table lookups for several (for example, K) of the L-bit units, Bᵢ, to allow K data-independent look-ups to take place. In order to achieve deferral of the data-dependent look-up stage, one or more compression tables are built for use in K data-independent table look-ups that are launched independently.

It is possible to postpone the data-dependent table look-ups due to the absence of carry propagation for addition operations on polynomials having a base Galois Field (GF(2ⁿ)), i.e. there is no carry propagation for XOR operations on binary strings. Consequently, through recursive application of data-independent table look-ups 202, 204, the N-bit binary string, B is compressed to form a compressed binary string, B′, 206 having a same CRC_{M} value as the N-bit binary string, B. The theory supporting the above compression of the N-bit binary string, B, will now be explained in greater detail.

The skilled person should understand that in order for compression to be possible a congruence equivalence has to exist. In this respect, it can be proven that a given function, A(x), is congruent to B(x) modulo G(x) if and only if there exists another function, Q(x), such that A(x)−B(x)=Q(x)G(x). For the sake of conciseness of description, an actual proof of the above congruence equivalence has been omitted herein.

Referring to FIG. 3, the L-bit units, Bᵢ, are arranged as vectors, vᵢ(x), 300 each consisting of K L-bit units. Consequently, a given vector, vᵢ(x), 300 is defined as vᵢ(x)=B_{K*i}(x) B_{(K*i+1)}(x) B_{(K*1+2)}(X) . . . B_{(K*i+K-1)}(x), where i=0, 1, . . . , m−1. For example, if L=8 and K=16, an L-bit unit is a byte and, in the context of the MC7447 microprocessor, a vector is an AltiVec vector. The N-bit data frame, B(x) 200 can therefore be expressed as:

$$\begin{matrix}B ( x ) = {b}_{0} {x}^{n - 1} + {b}_{1} {x}^{n - 2} + … {b}_{n - 1} \\ = {B}_{0} {x}^{( S - 1 ) L} + {B}_{1} {x}^{( S - 2 ) L} + … {B}_{S - 1} \\ = ( {v}_{0} ( x ) {x}^{( m - 2 ) KL} + {v}_{1} ( x ) {x}^{( m - 3 ) KL} + … {v}_{m - 2} ( x ) ) {x}^{T} + t ( x ) \\ = W ( x ) {x}^{T} + t ( x )\end{matrix}$$

where the W(x) is an “integral part” 302 of the N-bit binary string, B, and t(x) is a T-bit trailer 304 or “left-over part”. In this respect, to constitute the N-bit binary string, B, m vectors are needed, but since m vectors results in a string of greater length than N-bits, the difference between the first (m−1) vectors 300 and the N-bits is the T-bit trailer 304 that is shorter than one vector in length. The integral part W(x) 302 therefore constitutes a first (m−1) complete vectors.

It can be proven that (W(x )−Q(x)G(x))x^{T}+t(x) is congruent to B(x) modulo G(x) where Q(x) is an arbitrary function. However, for the sake of conciseness the proof will not be described herein. The congruence holds when Q(x)G(x) is subtracted from W(x), the integral part of B(x), i.e. after subtracting a multiple of G(x) from the integral part of the data frame; the result of the subtraction still has a same CRC value as the N-bit string of the data frame, B(x) 200.

In relation to the integral part 302, the integral part 302 can be expressed as:

W(x)=v₀(x)x^{(m-2)KL}+v₁(x)x^{(m-3)KL}+v₂(x)x^{(m-4)KL}+. . . +vₘ₋₂(x)

Taking a first term, v₀(x)x^{(m-2)KL}, of the above expression for the integral part W(x) 302, the first term, v₀(x)x^{(m-2)KL}, can be expressed as follows:

v₀(x)x^{(m-2)KL}=(B₀x^{(K-1)L}+B₁x^{(K-2)L}+ . . . B_{K-2}x^{L}+B_{K-1})x^{(m-2)KL}

In order to achieve compression of the data frame, B(x), 200 it is necessary to replace the first term, v₀(x)x^{(m-2)KL}, with a congruent polynomial having a lower degree than the first term, v₀(x)x^{(m-2)KL}. The above replacement results in the integral part, W(x), 302 being reduced to W′(x) (not shown), W′(x) being one vector shorter in length than W(x). In this way, the same CRC code can be generated in respect of the resultant, compressed frame.

Furthermore, by introducing an integer C limiting the number of vectors updated, where 0<C<(m−2), the first term is equivalent to:

v₀(x)x^{(m-2)KL}=(B₀x^{CKL+(K-1)L}+B₁x^{CKL+(K-2)L}+ . . . +B_{K-2}x^{CKL+L}+B_{K-1}x^{CKL})x^{(m-2-C)KL}

For each Bᵢx^{CKL} term, where i=0, 1, . . . , K−1, there exists a function qᵢ(x), such that Bᵢx^{CKL}=qᵢ(x)G(x)+rᵢ(x); the degree of rᵢ(x) is less than the degree of G(x), i.e. deg rᵢ(x)<M. Consequently:

$${v}_{0} ( x ) {x}^{( m - 2 ) KL} - ( {q}_{0} ( x ) G ( x ) {x}^{( K - 1 ) L} + {q}_{1} ( x ) G ( x ) {x}^{\{ K - 2 ) L} + … + {q}_{K - 1} ( x ) G ( x ) ) {x}^{( m - 2 - C ) KL} = ( {B}_{0} {x}^{CKL + ( K - 1 ) L} + {B}_{1} {x}^{CKL + ( K - 2 ) L} + … + {B}_{K - 2} {x}^{CKL + L} + {B}_{K - 1} {x}^{CKL} ) {x}^{( m - 2 - C ) KL} - ( {q}_{0} ( x ) G ( x ) {x}^{( K - 1 ) L} + {q}_{1} ( x ) G ( x ) {x}^{( K - 2 ) L} + … + {q}_{K - 1} ( x ) G ( x ) ) {x}^{( m - 2 - C ) KL} = ( {r}_{0} {x}^{( K - 1 ) L} + {r}_{1} {x}^{( K - 2 ) L} + … {r}_{K - 2} {x}^{L} + {r}_{K - 1} ) {x}^{KL ( m - 2 - C )}$$

The above expression is equivalent to:

v₀(x)x^{(m-2)KL}=(r₀x^{(K-1)L}+r₁x^{(K-2)L}+ . . . +r_{K-2}x^{L}+r_{K-1})x^{(m-2-C)KL}mod G(x)

The term, rᵢ=Bᵢx^{CKL} mod G(x), is thus pre-calculated and stored in a compression look-up table LTU(Bᵢ) for Bᵢ=0, 1, . . . 2^{L}−1. The term, rᵢ=LTU(Bᵢ), may overlap with a subsequent term, rᵢ₊₁=LTU(Bᵢ₊₁), but the same compression look-up table is nevertheless used to achieve the result of an operand modulo multiplied by x^{CKL}.

At this stage, the first term, v₀, is eliminated while the subsequent terms, v₁, v₂, . . . , v_{C}, are updated as v₁′, v₂′, . . . , v_{C}′, such that:

$$\begin{matrix}{W}^{′} = {v}_{1}^{′} {v}_{2}^{′} … {v}_{C}^{′} {v}_{c + 1} … {v}_{m - 2} \\ = ( ( {v}_{1} {v}_{2} … {v}_{C} ) + ( {r}_{0} {x}^{( K - 1 ) L} + \\ {r}_{1} {x}^{( K - 2 ) L} + … + {r}_{K - 2} {x}^{L} + {r}_{K - 1} ) {x}^{( m - 2 - C ) KL} ) \vert \vert\end{matrix}$$

(v_{c+1} . . . vₘ₋₂),

and

B(x)=W(x)x^{T}+t(x)=W′(x)x^{T}+t(x) modulo G(x)

From the above illustration, it can be seen that W(x)=W′(x) mod G(x), where W′(x) is the compressed integral part resulting from elimination of the leading vector (first term), v₀, and shifting and performing XOR operations on the results of the compression table look-ups r₀, r₁, . . . r_{K-1}.

Hence, by recursively applying the above approach to a leading vector of the N-bit binary string, a binary string of arbitrary length can be reduced to a binary string having C vectors as a compressed integral part thereof. The reduced binary string is congruent to the original binary string modulo G(x).

In practice, the integer C is chosen as 2 in order to ensure that a final lookup result from the compression look-up table, LUT(B_{K-1}), is right aligned with v₂, and hence to avoid wasting processor resources as only v₁ and V2 need updating. However, other values can be chosen for the integer, C, to postpone the data-dependency further.

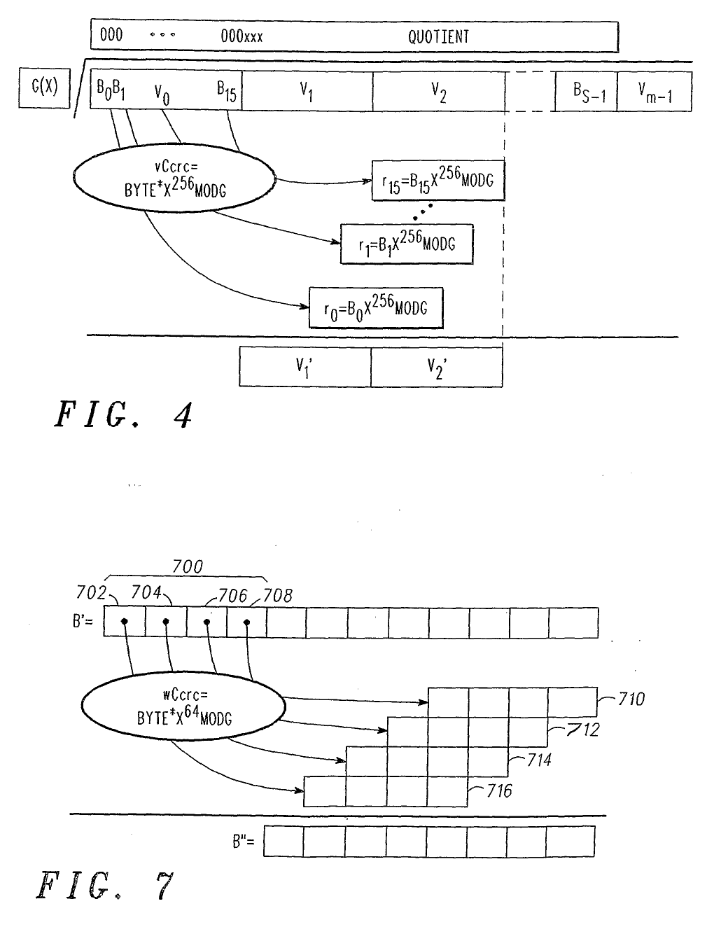

In relation to a vector-based parallel processor, such as the AltiVec engine (FIG. 4), variables L, K and C are set, in one example, to 8, 16 and 2, respectively. By applying the LUT(Byte) (=Byte*x²⁵⁶), the N-bit binary string B(x) is reduced one vector at a time until two complete, but modified, vectors vₘ₋₃′ and vₘ₋₂′ remain. The N-bit binary string B(x) is compressed into a binary string comprising vectors v_{m-3′, v}ₘ₋₂′, vₘ₋₁ if vₘ₋₁ is not fully occupied by the input bit string.

As mentioned above, rᵢ, where i=0, 1, . . . , 15 is a remainder of byte i, Bᵢ, of vector j, vⱼ, times x²⁵⁶ with respect to the function G(x), i.e. Bᵢ*x²⁵⁶ mod G(x). For the function G(x) with degree of M, each remainder, rᵢ, occupies M bits.

The AltiVec engine is capable of carrying out 16 Bᵢ*x²⁵⁶ mod G(x) look-ups for i=0, 1, . . . , 15 in parallel by splitting each byte to be looked-up into a corresponding pair of nibbles, namely a high nibble, Hᵢ, and a low nibble, Lᵢ. In this way, the following expression illustrates that the same result as Bᵢ*x²⁵⁶ can be achieved by carrying out look-ups in respect of nibble pairs:

Bᵢ*x²⁵⁶=(Hᵢ+*x⁴+Lᵢ)*x²⁵⁶=Hᵢ*x²⁶⁰+Lᵢ*x²⁵⁶ mod G

Hence instead of a single compression look-up table for vector-based parallel processing, two 16-entry compression look-up tables are employed: one in respect of the high nibble (LUTH) and one in respect of the low nibble(LUTL):

LUTH(H)=H*x²⁶⁰ mod G,

and

LUTL(L)=L*x²⁵⁶ mod G.

Combining results obtained from these look-up tables (using an XOR operation) allows results to be obtained equivalent to using a single compression look-up table:

LTU(HL)=LUTH(H)+LUTL(L)

The remainders obtained are staggered or “staircased” in M-bit wide blocks, i.e. the result of mod G(x), as a result of the long division, effectively being arranged for the performance of XOR operations as shown in FIG. 4. However, such performance of XOR operations on the remainders obtained and the initial vectors v1:v2 is unnecessarily computationally complex. However, the results can be grouped together. Referring to FIG. 5, each nibble pair look-up result 500 is displaced relative to a subsequent nibble pair look-up result due to the bit position in the N-bit binary stream, B(x), of a nibble being looked-up and either the x²⁶⁰ component in respect of the high nibbles or the x²⁵⁶ component in respect of the low nibbles. Nevertheless, due to the associative nature of the XOR operation, the nibbles of like bit positions 502, 504, 506, 508 within look-up results can be aligned as shown in FIG. 5, thereby permitting simplified register-based XOR operations to be performed.

In another embodiment, if the vectors v₀, v₁, v₂ . . . vₘ₋₁, are assumed to be shorter in length, in particular, four bytes in length each, then the scalar core of the processing resource 100 can compress the N-bit binary string, B(x), on a word-wise basis in accordance with the principles already described herein. In a further embodiment, the vector-based compression technique described above can be used to generate an intermediate compressed binary string that is subsequently subjected to a word-wise compression by arranging the vectors as units of smaller lengths, i.e. words.

The above compression technique will now be described in the context of CRC12. However, the skilled person will appreciate that other variants of CRC can be implemented using the above technique. In operation (FIG. 6), the LSU 104 of the processing resource 100 receives (Step 600) the N-bit string, B(x).

The number of vectors (vecs) is then calculated (Step 602) along with the number of trailing bytes, which is used to determine the number of words (words) 612 after vector compression has been completed, of the N-bit binary string. The N-bit string, B(x), is then arranged as a series of vectors, v0, v1, v2, followed by the T-bit trailer 304 comprising a trailing word, Tw0, and a trailing byte TB0.

$$\begin{matrix}B ( x ) = v 0 \text{:} v 1 \text{:} v 2 \text{:} w 0 \text{:} B 0 \\ = 99 F 1 E 2 D 3 C 4 B 5 A 697 \; 4 C 3 D 2 E 1 F \text{:} \\ 10111213 \; 14151617 \; 18191 A 1 B 1 C 1 D 1 E 1 F \text{:} \\ 20212223 \; 24252627 \; 28292 A 2 B 2 C 2 D 2 E 2 F \text{:} \\ 30313233 \text{:} \\ 84\end{matrix} \qquad \begin{matrix} \\ ( v 0 ) \\ ( v 1 ) \\ ( v2 ) \\ ( Tw0 ) \\ ( TB0 )\end{matrix}$$

According to the conventional method of generating a CRC12B, the CRC12B in respect of the N-bit binary string, B(x), is CRC12B(B(x))=0xF19. However, using the above described improved CRC code generation technique, a same CRC code can be generated as the CRC12B code generated by the conventional method.

In this respect, the LSU 104 implements a loop, by firstly initializing (Step 604) a counter, i, to zero. The LSU 104 then verifies (Step 606) that the counter is less than a vector number that is two less than the total number of vectors, vecs. The LSU 104, in conjunction with the AltiVec engine 107, then performs a compression iteration (Step 608) in respect of a vector corresponding to the counter. The compression iteration is performed as follows.

Firstly, the first vector, v0, is broken into a high nibble vector, vH, and a low nibble vector, vL, such that:

vH=9FED CBA9 0765 4321

vL=9123 4567 89AB CDEF

Due to the fact that the processing resource 100 is operating on vectors for this stage of the improved CRC algorithm, a first compression look-up table (Table 1, below) and second compression look-up table (Table 2, below) is used, generated using the already described algebraic technique.

Four vectors are needed to store each of the first and second vector compression tables to facilitate a so-called “vperm” instruction supported by the AltiVec engine 107. The first compression table is used in relation to Low (L)-nibble vectors and the second compression table is used in relation to High (H)-nibble vectors. Further, a two-byte result of a parallel nibble look-up needs two vectors to store.

TABLE 1

| Byte | L-Nibble Vector |
|---|---|
| MS(0) | 0x00, 0x09, 0x0A, 0x03, 0x0D, 0x04, 0x07, 0x0E, |
| | 0x03, 0x0A, 0x09, 0x00, 0x0E, 0x07, 0x04, 0x0D |
| LS(1) | 0x00, 0x79, 0xFD, 0x84, 0xF5, 0x8C, 0x08, 0x71, |
| | 0xE5, 0x9C, 0x18, 0x61, 0x10, 0x69, 0xED, 0x94 |

TABLE 2

| Byte | H-Nibble Vector |
|---|---|
| MS(0) | 0x00, 0x07, 0x0F, 0x08, 0x07, 0x00, 0x08, 0x0F, |
| | 0x0E, 0x09, 0x01, 0x06, 0x09, 0x0E, 0x06, 0x01 |
| LS(1) | 0x00, 0xCA, 0x94, 0x5E, 0x27, 0xED, 0xB3, 0x79, |
| | 0x4E, 0x84, 0xDA, 0x10, 0x69, 0xA3, 0xFD, 0x37 |

The first and second compression look-up tables are then accessed by the AltiVec engine 107 to obtain Most Significant (MS) bytes corresponding to the high and low nibble vectors vH and vL:

vCcrc12_MSB(vH)=0901060e09060109000f080007080f07

vCcrc12_MSB(vL)=0a090a030d04070e030a09000e07040d

The results of the above two compression table look-ups are then subjected to an XOR operation:

$$\begin{matrix}vCcrc12\_MSB ( v 0 ) = vCvrv12\_MSB ( vH ) ⊕ vCcrc12\_MSB ( vL ) \\ = 03080 c 0 d 0402060703050100090 f 0 b 0 a\end{matrix}$$

to generate the MS bytes for the compression of the first vector, v0. The first and second compression look-up tables are then accessed again to obtain Least Significant (LS) bytes corresponding to the high and low nibble vectors vH and vL:

vCcrc12_LSB(vH)=8437fda36910da840079b3ed275e94ca

vCcrc12_LSB(vL)=9c79fd84f58c0871e59c18611069ed94

The results of the above two compression table look-ups are then subjected to an XOR operation:

$$\begin{matrix}vCcrc12\_LSB ( v 0 ) = vCvrv12\_LSB ( vH ) ⊕ vCcrc12\_LSB ( vL ) \\ = 184 E 00279 C 9 CD 2 F 5 E 5 E 5 AB 8 C 3737795 E\end{matrix}$$

As can be seen from FIG. 5, by shifting the MSB result by 8 bits and performing an XOR operation on the 8-bit shifted MSB result and the LSB result, yields:

(vCcrc12_MSB(v0)<<8)⊕(vCcrc12_LSB(v0H)((vCcrc12_LSB(vL))=03:10420d239e9ad5f6e0e4ab85383c735e

The counter, i, is then incremented (Step 610) and the LTU 104 determines (Step 606) once again whether the counter is still less than (vec−2) vectors. Depending upon the size of the N-bit binary string, B(x), the above process of table look-ups is repeated (Steps 608, 610, 606) until all bytes in the (vec−2) vectors forming the vectors being compressed have been looked-up.

In the present example, the N-bit string only comprises 3 vectors and so after one iteration of the above process (Step 408), another XOR operation is performed on the result of the previous XOR operation as well as the first and second vectors, v1:v2 to yield a partially compressed string of bits B′, constituting the elimination of the first vector, v0, from B(x):

$$\begin{matrix}{B}^{′} = 10111213 \; 14151617 \; 18191 a 1 b 1 c 1 d 1 e 1 c \text{:} \\ 30632 f 00 babff 3 d 1 c 8 c d 81 ae 14115 d 71 \text{:} \\ 30313233 \text{:} \\ 84 \\ = w 1 \text{:} w 2 \text{:} w 3 \text{:} w 4 \text{:} \\ w 5 \text{:} w 6 \text{:} w 7 \text{:} w 8 \text{:} \\ Tw 0 \text{:} \\ TB 0\end{matrix} \qquad \begin{matrix}( v {1}^{′} ) \\ ( v {2}^{′} ) \\ ( Tw 0 ) \\ ( TB 0 )\end{matrix}$$

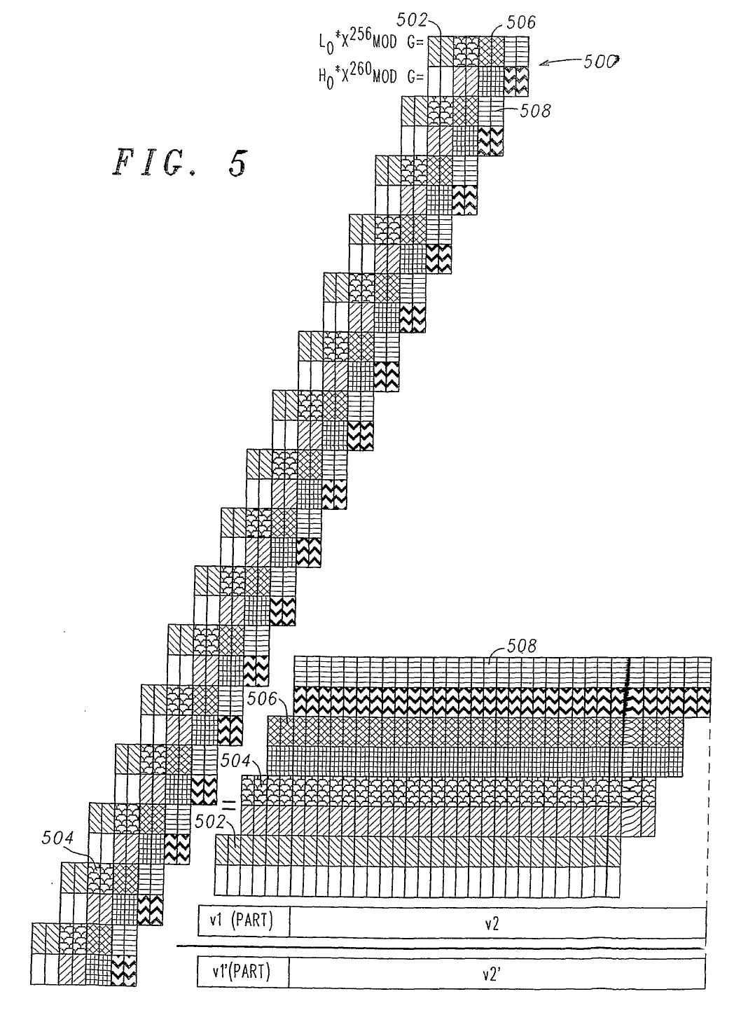

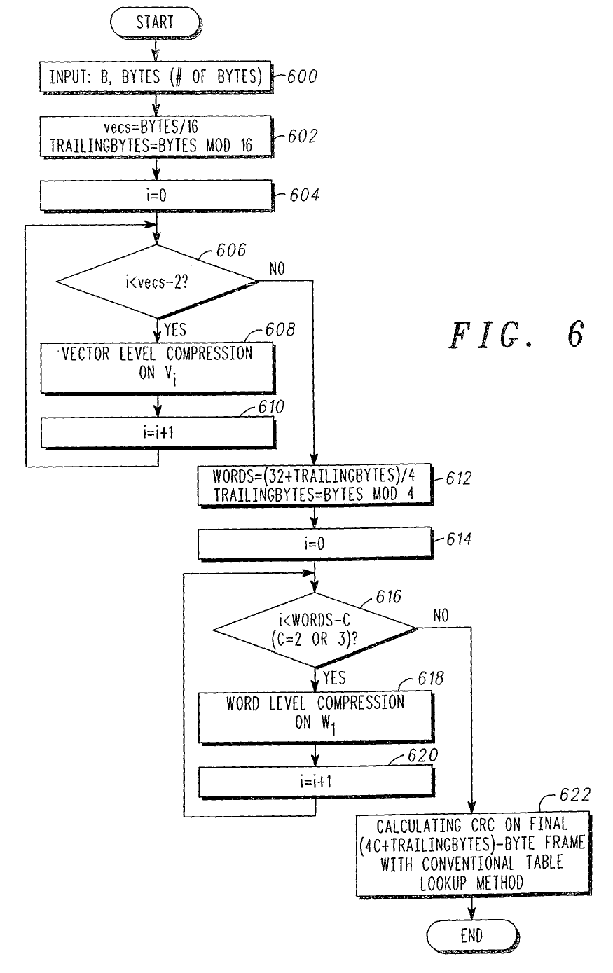

Thereafter, the processing resource 100 switches from compressing the N-bit string on a vector basis to a word compression basis (FIGS. 6 and 7) described previously, since less than 3 vectors are available for calculating the CRC12, namely: v1′:v2′=w1:w2:w3:w4:w5:w6:w7:w8. In FIG. 7, a first word (w1) 700 comprises a first byte pair 702, a second byte pair 704, a third byte pair 706, and a fourth byte pair 708 and are shown as being looked-up.

In this respect, the LTU 104 calculates (Step 612) the number of words based upon the length of the vectors of the previous iteration using the AltiVec engine 107 (32 bytes) and the number of bytes in the trailer 304; the number of bytes in the trailer 304 being calculated as (bytes mod 4). Thereafter, the LTU 104 re-initialises (Step 614) the counter, i, to zero and determines (Step 616) whether the counter is less than the number of words less the constant, c. In this example, the constant c is 2 as mentioned above so as to preserve right alignment. Since this is the first iteration of the word-wise compression, the processing resource 100 proceeds to access a word (4-byte) compression table (Table 3, below). Each entry in the word compression table is 2-bytes wide and padded with 4 binary leading zeros to facilitate right byte-alignment.

TABLE 3
0x0000, 0x0645, 0x0C8A, 0x0ACF, 0x011B, 0x075E, 0x0D91, 0x0BD4,
0x0236, 0x0473, 0x0EBC, 0x08F9, 0x032D, 0x0568, 0x0FA7, 0x09E2,
0x046C, 0x0229, 0x08E6, 0x0EA3, 0x0577, 0x0332, 0x09FD, 0x0FB8,
0x065A, 0x001F, 0x0AD0, 0x0C95, 0x0741, 0x0104, 0x0BCB, 0x0D8E,
0x08D8, 0x0E9D, 0x0452, 0x0217, 0x09C3, 0x0F86, 0x0549, 0x030C,
0x0AEE, 0x0CAB, 0x0664, 0x0021, 0x0BF5, 0x0DB0, 0x077F, 0x013A,
0x0CB4, 0x0AF1, 0x003E, 0x067B, 0x0DAF, 0x0BEA, 0x0125, 0x0760,
0x0E82, 0x08C7, 0x0208, 0x044D, 0x0F99, 0x09DC, 0x0313, 0x0556,
0x09BF, 0x0FFA, 0x0535, 0x0370, 0x08A4, 0x0EE1, 0x042E, 0x026B,
0x0B89, 0x0DCC, 0x0703, 0x0146, 0x0A92, 0x0CD7, 0x0618, 0x005D,
0x0DD3, 0x0B96, 0x0159, 0x071C, 0x0CC8, 0x0A8D, 0x0042, 0x0607,
0x0FE5, 0x09A0, 0x036F, 0x052A, 0x0EFE, 0x08BB, 0x0274, 0x0431,
0x0167, 0x0722, 0x0DED, 0x0BA8, 0x007C, 0x0639, 0x0CF6, 0x0AB3,
0x0351, 0x0514, 0x0FDB, 0x099E, 0x024A, 0x040F, 0x0EC0, 0x0885,
0x050B, 0x034E, 0x0981, 0x0FC4, 0x0410, 0x0255, 0x089A, 0x0EDF,
0x073D, 0x0178, 0x0BB7, 0x0DF2, 0x0626, 0x0063, 0x0AAC, 0x0CE9,
0x0B71, 0x0D34, 0x07FB, 0x01BE, 0x0A6A, 0x0C2F, 0x06E0, 0x00A5,
0x0947, 0x0F02, 0x05CD, 0x0388, 0x085C, 0x0E19, 0x04D6, 0x0293,
0x0F1D, 0x0958, 0x0397, 0x05D2, 0x0E06, 0x0843, 0x028C, 0x04C9,
0x0D2B, 0x0B6E, 0x01A1, 0x07E4, 0x0C30, 0x0A75, 0x00BA, 0x06FF,
0x03A9, 0x05EC, 0x0F23, 0x0966, 0x02B2, 0x04F7, 0x0E38, 0x087D,
0x019F, 0x07DA, 0x0D15, 0x0B50, 0x0084, 0x06C1, 0x0C0E, 0x0A4B,
0x07C5, 0x0180, 0x0B4F, 0x0D0A, 0x06DE, 0x009B, 0x0A54, 0x0C11,
0x05F3, 0x03B6, 0x0979, 0x0F3C, 0x04E8, 0x02AD, 0x0862, 0x0E27,
0x02CE, 0x048B, 0x0E44, 0x0801, 0x03D5, 0x0590, 0x0F5F, 0x091A,
0x0OF8, 0x06BD, 0x0C72, 0x0A37, 0x01E3, 0x07A6, 0x0D69, 0x0B2C,
0x06A2, 0x00E7, 0x0A28, 0x0C6D, 0x07B9, 0x01FC, 0x0B33, 0x0D76,
0x0494, 0x02D1, 0x081E, 0x0E5B, 0x058F, 0x03CA, 0x0905, 0x0F40,
0x0A16, 0x0C53, 0x069C, 0x00D9, 0x0B0D, 0x0D48, 0x0787, 0x01C2,
0x0820, 0x0E65, 0x04AA, 0x02EF, 0x093B, 0x0F7E, 0x05B1, 0x03F4,
0x0E7A, 0x083F, 0x02F0, 0x04B5, 0x0F61, 0x0924, 0x03EB, 0x05AE,
0x0C4C, 0x0A09, 0x00C6, 0x0683, 0x0D57, 0x0B12, 0x01DD, 0x0798.

Consequently, the LSU 104 initially accesses the word compression table to looks-up each word in the partially compressed string B′, Hence, for the first word 700 (w1), the look-up results are as follows:

wCcrc12(10)=46C (reference 710)

wCcrc12(11)=229 (reference 712)

wCcrc12(12)=8E6 (reference 714)

wCcrc12(13)=EA3 (reference 716)

Thereafter, an XOR operation is performed on the 4 results of the above look-ups and w2:w3 in order to obtain w2′:w3′:

w2′:w3′=14151617 18191a1b

⊕ 4 6C

⊕ 229

⊕ 8E6

⊕ EA3

14151613 7638F2B8

thereby reducing the partially compressed string B′(x), since the first word, w1, is eliminated. Hence, a first iteration of the word-wise compression (Step 618) results in a further compressed binary string, B″:

B″=14151613:7638F2B8:18191a1b:1c1d1e1c:30632f00: babff3d1:c8cd81ae:14115d71:30313233:84=w2′:w3′:w4:w5:w6:w7:w8:w0:B0

The counter, i, is then incremented (Step 620) and the LSU 104 again determines (Step 616) whether the counter is still less than the predetermined maximum of (word-c). In the present example, the counter, i, is still less than (word-c) and so the word-wise compression process is repeated (Step 618) using the further compressed binary string B″, resulting in a final compressed binary string B′″:

B′″=7a1747a5: 0xaf156735:30313233:84

At this point, it should be pointed out that the final compressed binary string B′″ cannot be compressed further, but that it has a same CRC12 value/code as the N-bit binary string, B.

The conventional known CRC12 algorithm is therefore applied (Step 422) to the final compressed binary string B′″, resulting in:

crc12B(B′″)=0xF19

This is the same result as previously stated above in relation to performing the conventional CRC algorithm exclusively on the N-bit binary string. As can be seen from the above example, other than in relation to the conventional CRC12 algorithm, the compression table look-ups performed above are data-independent. It is thus possible to provide a method of generating a code for verifying integrity of data and an apparatus therefor that is capable incorporating more instructions into a given number of CPU cycles than through use of existing data-dependent CRC algorithms. Consequently, higher performance is achieved through the increase in Instructions Per Cycle (IPC).

The above described example using exemplary data employed both vector-based and word-wise compression of the N-bit binary string 200. However, the skilled person will appreciate that either the vector-based implementation can also be used as a sole means of compressing the N-bit binary string 200 prior to implementing the conventional CRC algorithm, or the word-wise implementation can alternatively be used as the sole means of compressing the N-bit string prior to implementing the conventional CRC algorithm.

Although, in the above examples, a single microprocessor constitutes the processing resource 100, the skilled person will appreciate that more than one suitably-equipped processing unit can constitute the processing resource 100.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

1. A method of generating a code for verifying integrity of data, the method comprising:
receiving a string of bits;
performing a plurality of look-ups with respect to a compression data so as to form a compressed string of bits from the received string of bits, the compressed string of bits being congruent with the received string of bits with respect to a predetermined polynomial modulo function; and
generating the code in respect of the string of bits by applying a conventional code generation algorithm to the compressed string of bits.

2. A method as claimed in claim 1, wherein the code is a Cyclic Redundancy Checking (CRC) code.

3. A method as claimed in claim 1, wherein the string of bits comprises an integral part binary string and a plurality of trailing bits (304).

4. A method as claimed in claim 3, wherein the compressed string of bits comprises a compressed integral part binary string and the plurality of trailing bits.

5. A method as claimed in claim 1, wherein the conventional code generation algorithm employs a data-dependent look-up table.

6. A method as claimed in claim 1, wherein the integral part binary string comprises a first plurality of binary vectors, and the compressed integral part binary string comprising a second plurality of binary vectors, the second plurality of binary vectors being fewer in number to the first plurality of binary vectors.

7-17. (canceled)

18. A method as claimed in claim 1, wherein the compression data is stored as at least one look-up table.

19. A computer program element comprising computer program code means to make a computer execute the method as claimed in claim 1.

20. A computer program element as claimed in claim 19, embodied on a computer readable medium.

21. A processing apparatus for generating a code to verifying integrity of data, the apparatus comprising:
an input for receiving a string of bits;
a processing resource coupled to the input;
the processing resource is arranged to perform, when in use, a plurality of look-ups with respect to compression data so as to form a compressed string of bits from the received string of bits, the compressed string of bits being congruent with the received string of bits with respect to a predetermined polynomial modulo function, wherein the processing resource is further arranged to generate, when in use, a code in respect of the string of bits by applying a conventional code generation algorithm to the compressed string of bits.

22. An apparatus as claimed in claim 21, wherein the processing resource is arranged to perform, when in use, the plurality of look-ups in parallel.

23. An apparatus as claimed in claim 21, wherein the processing resource comprises a vector processor to perform, when in use, the plurality of look-ups in parallel.

24. An apparatus as claimed in claim 21, wherein the processing resource supports a Single Instruction Multiple Data (SIMD) instruction set to perform, when in use, the plurality of look-ups in parallel.

25. An apparatus as claimed in claim 21, wherein the processing resource comprises at least a scalar core for generating the compressed string of bits.

26. An apparatus as claimed in claim 21, wherein the processing resource is arranged to perform, when in use, a number of the plurality of look-ups in parallel so as to generate an intermediate compressed string of bits.

27. An apparatus as claimed in claim 21, wherein the processing resource comprises at least a scalar core for generating the compressed string of bits from the intermediate compressed string of bits.

28. An apparatus as claimed in claim 21, wherein the compression data is modulo arithmetic remainder data.

29. An apparatus as claimed in claim 21, wherein the compression data is stored as at least one look-up table.

30. A communications apparatus comprising the processing apparatus as claimed in claim 21.

31. A computing apparatus comprising the processing apparatus as claims in claim 21.
